(19) United States
(12) Patent Application Publication
(10) Pub. No.: US 2004/0230418 A1
(43) Pub. Date: Nov. 18, 2004

(54) Bilingual structural alignment system and method

(76) Inventor: Mihoko Kitamura, Kyoto (JP)

Correspondence Address: RABIN & Berdo, PC, 1101 14TH STREET, NW, SUITE 500, WASHINGTON, DC, 20005, US

(21) Appl. No.: 10/738,260

(22) Filed: Dec. 18, 2003

(30) Foreign Application Priority Data
Dec. 19, 2002 (JP) 367553/2002

(51) Int. Cl. G06F 17/20

(52) U.S. Cl. 704/8

(57) ABSTRACT

In a bilingual dependency structural alignment system and method of the invention, in order to align the dependency structure of the first language sentences and the second language sentences of the bilingual text without complicating the processing but with good accuracy and to make the coverage of alignment higher, alignment is performed on the dependency structures of the first language sentence and the second language sentence in the bilingual document by a bilingual dictionary with degree of parallelism with a word or word string as a header, and, at the time thereof, if there is at least a part that can not be aligned and/or if there are plural candidates of correspondences in at least a part, the lacking alignment of the dependency structures is obtained or optimum correspondence of the plural candidates is determined, while satisfying the condition that the dependency structures are held in the first language sentence and the second language sentence, respectively, and on the condition that the evaluation value with the degree of parallelism becomes maximum.

### FIELD OF THE INVENTION

The present invention relates to a bilingual dependency structural alignment system for aligning dependency structure of the first language sentences and the second language sentences of a bilingual text, and a method therefor.

### BACKGROUND OF THE INVENTION

In order to automatically generate a bilingual dictionary or a grammatical rule for machine translation, a bilingual text consisted of the first language sentences (hereinafter, referred to as “original”) written in the first language (for example, Japanese) and the second language sentences (hereinafter, referred to as “translation”) written in the second language (for example, English) different from the first language is utilized. Further, in order to generate a bilingual dictionary and a grammatical rule, for the original and the translation of the bilingual text, respectively, the structures of the dependency relations (hereinafter, referred to as dependency structures) between their components (for example, phrases or morphemes) are obtained, and which part of the dependency structure of the original is aligned to which part of the dependency structure of the translation is determined.

As a conventional technology for such processing, for example, “Finding Translation Correspondences from Parallel Parsed Corpus for Example-Based Translation, E. Aramaki et al., Proceedings of MT-Summit VIII, pp. 27-32, 2001” is known.

In this conventional technology, a method for determining which part of the dependency structure of the original is aligned to which part of the dependency structure of the translation is proposed.

The alignment method disclosed in the conventional technology is constituted by the three steps of: (1) obtaining phrase for phrase dependency structures of the original and the translation; (2) using an existing bilingual dictionary, obtaining phrase for phrase alignment of the original and the translation; and (3) separately considering the alignment of the phrases that remain unable to be aligned. In the above step (2), three evaluation criteria are defined, and thereby, the step is constituted so that the optimum alignment may be obtained even if plural candidates exist when the alignment is performed by the bilingual dictionary.

Further, in the above step (3), by defining an evaluation function and a threshold for computing the degree of parallelism between the dependency structures, the alignment that has the highest value of the evaluation function and satisfies the threshold is obtained.

This conventional technology can be referred to as a sort of a bottom-up method for finding the alignment with the part found by the bilingual dictionary as a key.

However, in this conventional technology, the accuracy of the alignment depends on the size of the existing bilingual dictionary. In other words, there is a problem that the suitable alignment can not be performed unless the bilingual dictionary of a sufficient scale exists.

Further, there is another problem that there are a number of values to be set such as evaluation criteria used for alignment, and as a result, tuning for improving the result of the alignment is difficult.

Furthermore, since the alignment is performed not on the entire of the dependency structure tree, but only on the corresponding parts that satisfy the threshold, there is another problem that the coverage (ratio of the part the correspondences of which are found in the bilingual text) is low (the trial result with the bilingual text of the test set 100 is 61% as the maximum).

On this account, the realization of a bilingual dependency structural alignment method having high coverage and capable of aligning the dependency structures of the first language sentences and the second language sentences of the bilingual text without complicating processing but with good accuracy, and a system for executing the method has been required.

### SUMMARY OF THE INVENTION

In order to solve the above described problems and to align the dependency structures of the first language sentences and the second language sentences of the bilingual text without complicating processing but with good accuracy and to make the coverage of alignment higher, in a bilingual dependency structural alignment system and method of the invention, alignment is performed on the dependency structures of the first language sentence and the second language sentence in the bilingual document with a bilingual dictionary with degree of parallelism with a word or word string as a header, and, at the time thereof, if there is at least a part that can not be aligned, or there are plural candidates of correspondences in at least a part, the lacking alignment of the dependency structures is obtained or optimum alignment of the plural candidates is determined, while satisfying the condition that the dependency structures are held in the first language sentence and the second language sentence, respectively, and on the condition that the evaluation value with the degree of parallelism becomes maximum.

### BRIEF DESCRIPTION OF THE DRAWINGS

FIG. 1 is a block diagram showing the functional constitution of the bilingual dependency structural alignment system of the first embodiment.

FIG. 2 is a flowchart showing the dependency structure alignment processing of the first embodiment.

FIG. 3 is a flowchart showing the bilingual dictionary building processing of the first embodiment.

FIG. 4 is an explanatory diagram showing an example of the bilingual dictionary with degree of parallelism generated by the bilingual dictionary building processing of the first embodiment.

FIG. 5 is an explanatory diagram showing an example of the result of the dependency structure analysis of the first embodiment.

FIG. 6 is an explanatory, diagram representing the result of the dependency structure analysis in FIG. 5 by the tree structure.

FIG. 7 is a flowchart showing the dependency structure matching processing of the first embodiment.

FIG. 8 is an explanatory diagram showing the result of the dependency structure alignment at the stage using the bilingual dictionary with degree of parallelism in FIG. 4 for the result of the dependency structure analysis in FIG. 6.

FIG. 9 is an explanatory diagram showing the result of the dependency structure alignment after the alignment for the “remaining node” in FIG. 8.

FIG. 10 is an explanatory diagram showing an example of the output form of the result of the dependency structure alignment in FIG. 9.

FIG. 11 is a flowchart showing the dependency structure alignment processing of the second embodiment.

FIG. 12 is an explanatory diagram showing an example of the bilingual dictionary with degree of parallelism generated by the bilingual dictionary building processing of the second embodiment.

FIG. 13 is a flowchart showing the dependency structure matching processing of the second embodiment.

FIG. 14 is an explanatory diagram showing an example of the result of the alignment processing of dependency structure and dictionary of the second embodiment.

FIG. 15 is an explanatory diagram showing an example of the result of the final dependency structure alignment of the second embodiment.

FIG. 16 is a block diagram showing the functional constitution of the bilingual dependency structural alignment system of the third embodiment.

FIG. 17 is a flowchart showing details of the dictionary expansion processing of the third embodiment.

FIG. 18 is an explanatory diagram showing an example of the Japanese-English bilingual dictionary of the third embodiment.

FIG. 19 is an explanatory diagram showing an example of the English-Japanese bilingual dictionary of the third embodiment.

FIG. 20 is an explanatory diagram showing the result of the dictionary expansion processing of the third embodiment.

FIG. 21 is an explanatory diagram showing an example of the result of the final dependency structure alignment of the third embodiment.

FIG. 22 is a block diagram showing the functional constitution of the bilingual dependency structural alignment system (machine translation pattern generation system) of the fourth embodiment.

FIG. 23 is a flowchart showing the bilingual dictionary (translation pattern) generation processing of the fourth embodiment.

FIG. 24 is an explanatory diagram showing an example of the newly generated bilingual dictionary (translation pattern) of the fourth embodiment.

FIG. 25 is an explanatory diagram showing an example of the additionally registered bilingual dictionary (translation pattern) of the fourth embodiment.

### DETAILED DESCRIPTION OF THE PREFERRED EMBODIMENTS OF THE INVENTION

(1) The First Embodiment

Hereinafter, the first embodiment of the invention will be described by referring to the drawings. This first embodiment is designed so as to perform alignment on the entire of dependency structures of the original and the translation with good accuracy and good efficiency by using the resulting bilingual dictionary with degree of parallelism obtained as a result of aligning the word strings occurring in the original and the word strings occurring in the translation from the bilingual document by a statistical technique.

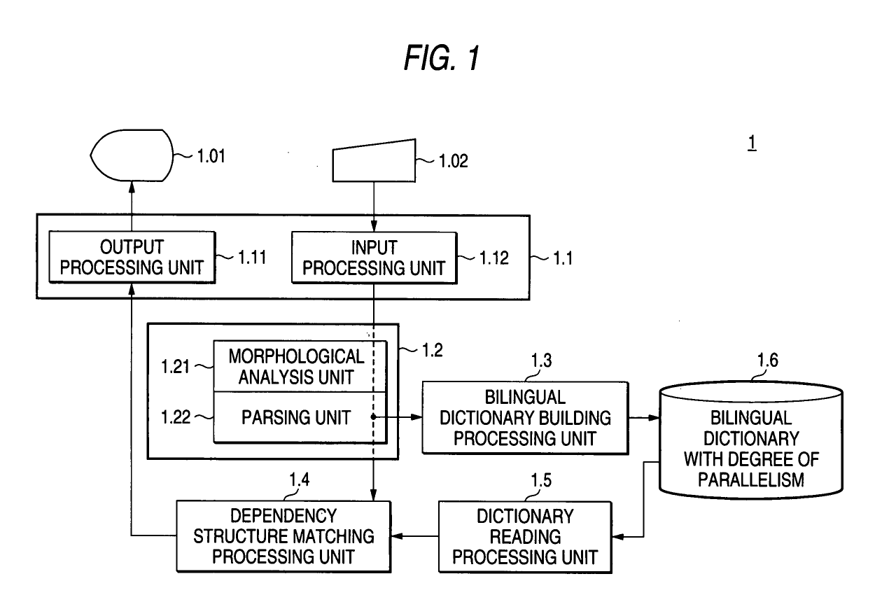

FIG. 1 is a block diagram showing the bilingual dependency structural alignment system of the first embodiment. For example, by installing the bilingual dependency structural alignment program stored in a storage medium such as a CD-ROM in a computer such as a personal computer (PC), this bilingual dependency structural alignment system of the first embodiment is realized, and the block diagram of FIG. 1 shows it as a functional constitution.

This bilingual dependency structural alignment system 1 of the first embodiment has an input/output unit 1.1, a dependency structure analysis unit 1.2, a bilingual dictionary building processing unit 1.3, a dependency structure matching processing unit 1.4, a dictionary reading processing unit 1.5, and a bilingual dictionary with degree of parallelism 1.6.

The input/output unit 1.1 is constituted by an input processing unit 1.12 for inputting a bilingual document for generating a bilingual dictionary from an input unit 1.02 and inputting a bilingual text (original and translation) for dependency structure alignment from the input unit 1.02, and an output processing unit 1.11 for outputting the alignment result of the dependency structures to output unit 1.01.

The input unit 1.02 is a device such as a keyboard for directly inputting text data. However, not limited to the above described device, but a storage medium access system for reading a bilingual document or a bilingual text from a built-in storage medium or a loaded storage medium, and a communication unit for capturing a bilingual document or a bilingual text from an external information processing system by communication can be also adopted.

For the output unit 1.01, for example, a display, a printer, a communication unit to an external information processing system, or a storage medium access system for writing data in a storage medium can be adopted.

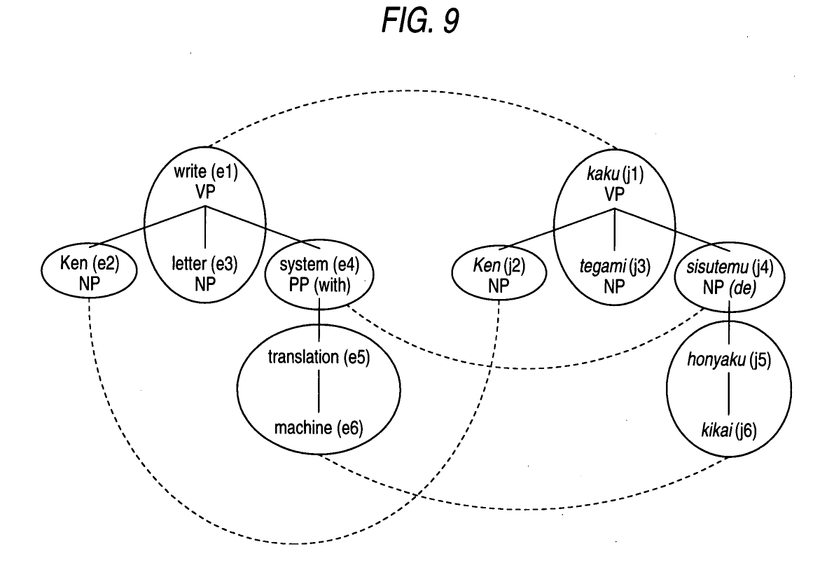

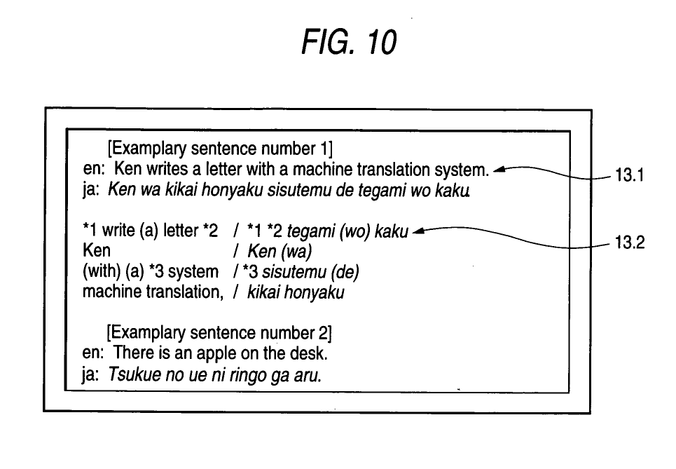

The dependency structure analysis unit 1.2 is for obtaining dependency structures of the original and translation of the bilingual text as shown in FIG. 9 and FIG. 10, respectively, which will be described later.

The processing by the dependency structure analysis unit 1.2 can be performed by applying a method by a modification analysis system utilizing a statistical technique disclosed in “http://cl/aist-nara.ac.jp/lab/nlt/NTL.html”, and a method (pattern-based technique) for obtaining an parsing result of the original side of “translation processing unit” disclosed in Publication of Japanese Patent Application No. 2002-41512, for example. Both of the above two methods have a morphological analysis unit 1.21 and a parsing unit 1.22, and can obtain the dependency structures of the sentences by performing the respective processing.

The bilingual dictionary building processing unit 1.3 is for performing generation of bilingual dictionary according to a statistical technique. As this bilingual dictionary generating method, a method disclosed in Publication of Japanese Patent Application No. Hei-10-11445 or Document 1 “Automatic Extraction of Bilingual Expression Using Parallel Corpora”, Kitamura et al., Information Processing Society of Japan Journal, Vol. 38, No. 4, April 1997 can be applied. The information of the bilingual dictionary with degree of parallelism generated by the bilingual dictionary building processing unit 1.3 is stored in the bilingual dictionary with degree of parallelism 1.6.

The dependency structure matching processing unit 1.4 is for performing alignment on the dependency structures of the original and the translation obtained in the dependency structure analysis unit 1.2 using the bilingual dictionary read by the dictionary reading processing unit 1.5.

The dictionary reading processing unit 1.5 is for normalizing the values of degree of parallelism assigned to the respective translation correspondences so that the dependency structure matching processing unit 1.4 may use them when the unit reads the bilingual dictionary from the bilingual dictionary with degree of parallelism 1.6.

Next, the operation of the bilingual dependency structural alignment system of the first embodiment will be described.

The basic flow of the operation is as follows.

The alignment of the dependency structures is performed with the bilingual dictionary and degree of parallelism that can be acquired by the statistical technique as a key. Note that there is a possibility that incorrect alignment exists at this time.

In order to obtain the optimum alignment as a whole, to which part the part that can not be aligned (remaining part) or the part having plural candidates is aligned is determined by utilizing the evaluation values using the evaluation function to perform computation of the evaluation values with respect to all possibilities, and selecting the result that has the highest evaluation value among them.

As below, the operation of the first embodiment will be described by taking an example of the case of generating the bilingual dictionary with degree of parallelism from translation examples and obtaining the alignment result of the dependency structures with respect to the following bilingual text consisted of the Japanese sentence and the English sentence, which exists in the translation examples.

Japanese Sentence: Ken wa kikai honyaku sisutemu de tegami wo kaku.

English Sentence: Ken writes a letter with a machine translation system.

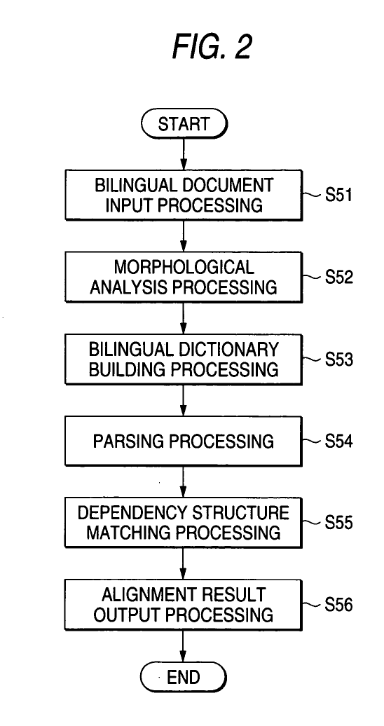

FIG. 2 is a flowchart showing the dependency structure alignment processing in the first embodiment.

The user inputs the file name of the translation examples, for example, to the input processing unit 1.12 using the input unit 1.02, and the input processing unit 1.12 captures the file and passes it to the morphological analysis unit 1.21 (S51). The morphological analysis unit 1.21 performs morphological analysis on the English sentences and the Japanese sentences in the file, respectively (S52), and passes them to the bilingual dictionary building processing unit 1.3.

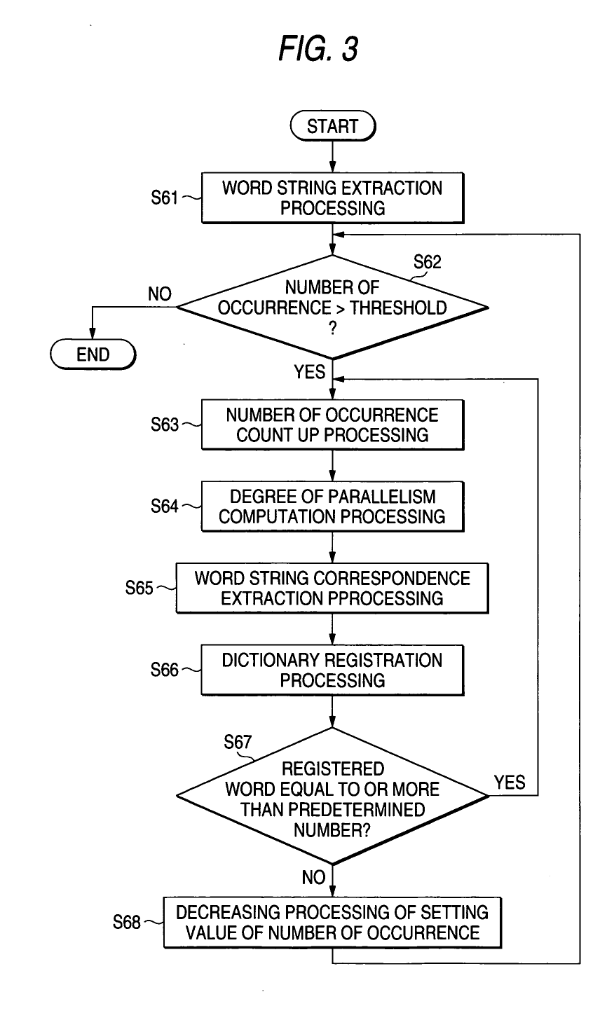

FIG. 3 is a flowchart showing the bilingual dictionary building processing executed by the bilingual dictionary building processing unit 1.3 (see the above described Publication of Japanese Patent Application No. Hei-10-11445 and Document 1).

First, the bilingual dictionary building processing unit 1.3 extracts word strings consisted of one ton words (generally, n is set to 5) from the morphological analysis result of the English sentences and the Japanese sentences received from the morphological analysis unit 1.21, respectively (S61).

Until the predetermined threshold of the number of occurrence is obtained (S62), while gradually reducing the setting value of the number of occurrence, the number of occurrence is determined for the word string having the number of occurrence equal to or more than the setting value (S63).

Then, the degree of parallelism of the English and Japanese word strings is calculated from the number of occurrence occurred simultaneously in both of the English and Japanese sentences (bilingual text) and the number of occurrence occurred singly in either of them (S64), pairs of word strings having values of degree of parallelism equal to or more than a certain value are extracted (S65), and the pairs of word strings and the degree of parallelism thereof are registered in the bilingual dictionary with degree of parallelism (S66).

If the number of words (the number of pairs) registered in the above step S66 is equal to or more than a certain number of words (S67), the processing from the step S63 to the step S66 are repeated again at the setting value of the number of occurrence.

If the number of words registered in the above step S66 is less than the certain predetermined number of words (S67), the number of occurrence is reduced (S68) and the processing from the step S62 to the step S67 are repeated again.

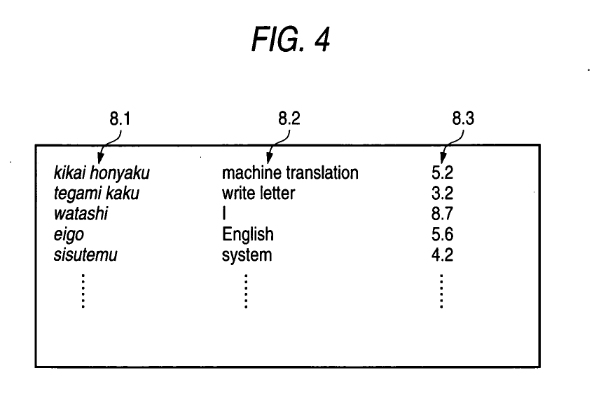

FIG. 4 is shows an example of the bilingual dictionary with degree of parallelism 1.6 generated by the bilingual dictionary building processing.

In this bilingual dictionary with degree of parallelism 1.6, the respective fields are separated by tabs and the first field 8.1 shows Japanese word strings, the second field 8.2 shows English word strings, and the third field 8.3 shows degree of parallelism.

Turning to FIG. 2, next, the parsing unit 1.22 obtains the result of the dependency structure analysis from the result of the morphological analysis of the translation examples (S54). The result of the dependency structure analysis of the translation examples is stored in the buffer in a state that English and Japanese sentences are aligned.

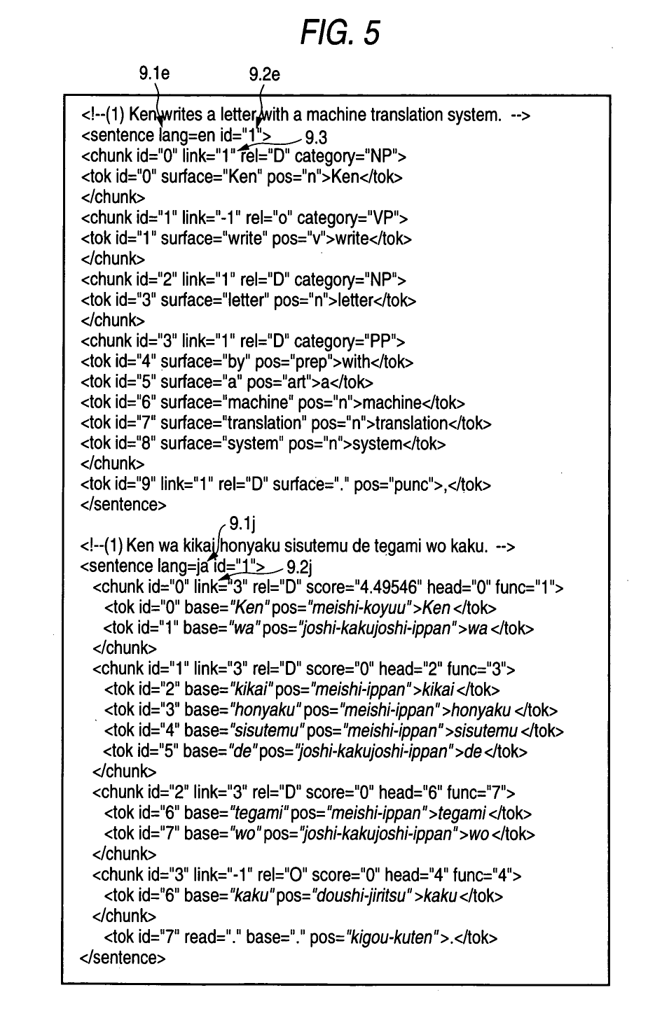

FIG. 5 shows an example of the result of the dependency structure analysis stored in the buffer. In this example, the result is expressed in the xml form, and the languages, sentence correspondences, or dependency relations between phrases are shown by lang(9.1e, 9.1j), id(9.2e, 9.2j) of sentences, or link(9.3) of chunks, respectively.

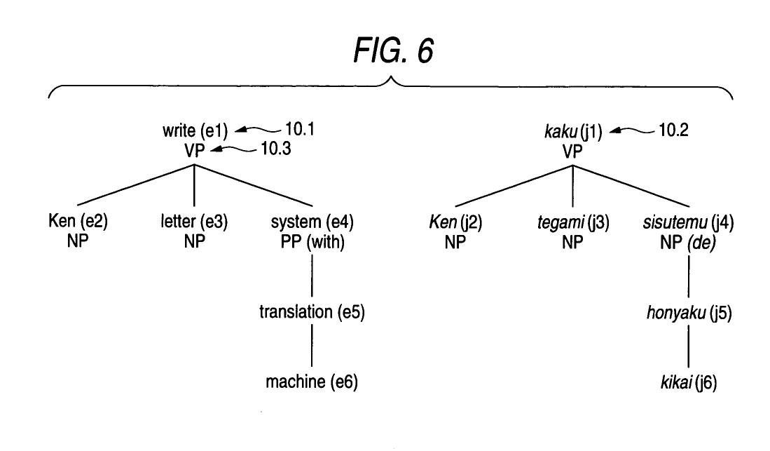

FIG. 6 shows an example in which FIG. 5 is represented in a tree structure form. The sign 10.1 shows the dependency structure tree of English, and the sign 10.2 shows the dependency structure tree of Japanese. In the following description, for simplification of the description, these tree structures will be used for description. Additionally, for simplification of the description, the respective nodes of the respective tree structures will be assigned with ids of e1, e2, . . . and j1, j2 . . .

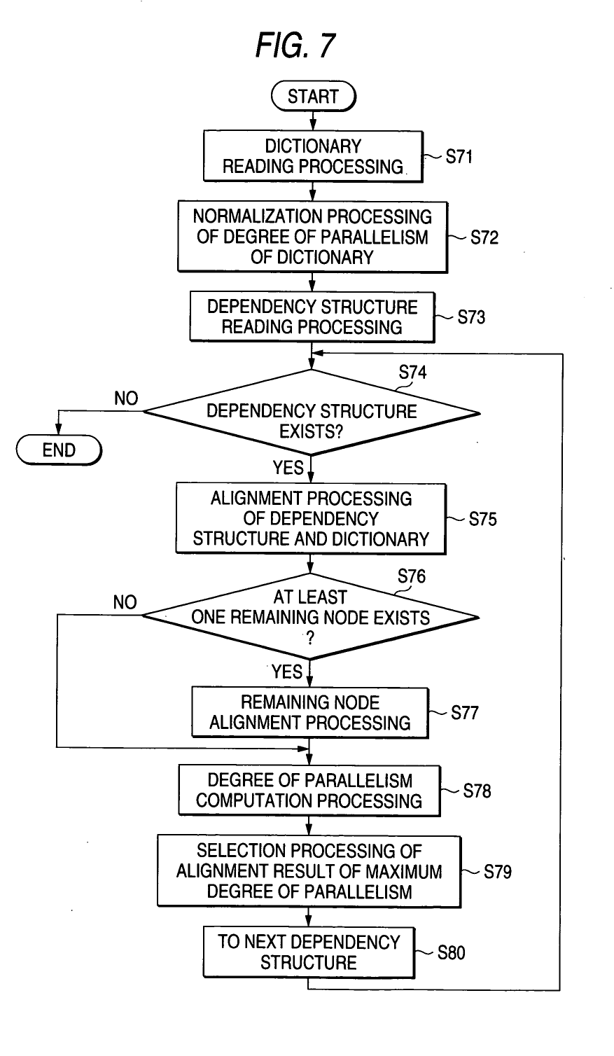

Turning to FIG. 2, next, the dependency structure matching processing is performed by the dependency structure matching processing unit 1.4, the dictionary reading processing unit 1.5, etc. (S55). FIG. 7 is a flowchart showing the dependency structure matching processing.

First, the bilingual dictionary with degree of parallelism 1.6 is read by the dictionary reading processing unit 1.5 (S71), and then, normalization processing is performed on the degrees of parallelism assigned to the respective translation correspondences (S72). Here, the normalization processing indicates processing for mapping the degree of parallelism of 0 to ∞ to the degree of parallelism of 0 to 1. For example, since the ratio of the correct correspondences is 100% if the old degree of parallelism is equal to or more than 4, the new degree of parallelism is made as 1, and if the value is less than 4, “old degree of parallelism x ¼”, is made as the new degree of parallelism. For example, if the old degree of parallelism is 3.2, 3.2/4=0.8 becomes the new degree of parallelism.

Next, the dependency structure matching processing unit 1.4 reads one result of the dependency structure analysis (dependency structure analysis tree) stored in the buffer, which is not shown, (S73), and if the dependency structure to be aligned exists, (reading is successfully performed) (S74), alignment processing of dependency structure and dictionary (S75) is performed.

This alignment processing of dependency structure and dictionary is processing of extracting all candidates of the part to be aligned with respect to the dependency structures of the original and the translation by the bilingual dictionary with degree of parallelism 1.6 under the restriction on holding of the dependency relations. In other words, that is processing of extracting all the dependency structures aligned by the information of the bilingual dictionary with degree of parallelism 1.6.

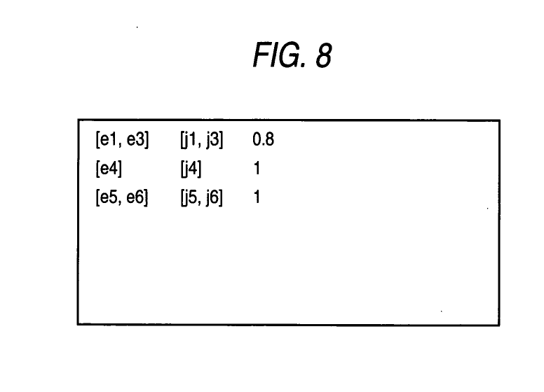

For example, in the case of the example of the bilingual dictionary with degree of parallelism in FIG. 4 and the result of the dependency structure analysis in FIG. 6, “tegami kaku/write letter”, “sisutemu/system”, “kikai honyaku/machine translation” are aligned. This alignment result is stored as pairs of ids of nodes as shown in FIG. 8.

Then, if not all of the nodes are aligned with the bilingual dictionary with degree of parallelism 1.6, in other words, if “remaining node” exists (S76), all candidates of this “remaining node” are extracted under the restriction on holding of the dependency relations (S77). The computation is performed on the candidates of alignment by applying the evaluation function (S78), the result of alignment in which the degree of parallelism becomes maximum (S79) is obtained.

As the evaluation function used here, for example, the evaluation function used in Document 2 “Automatic Acquisition of Translation Rules Using Parallel Corpora”, Kitamura et al., Information Processing Society of Japan Journal, Vol.37, No.6, June 1996” can be applied (see the above Document 2 regarding details about the evaluation function).

The above described step S77 to step S79 will be specifically described using the example in FIG. 6. In the case of FIG. 6, since “remaining nodes” are e2 and j2 (see FIG. 8), under the restriction on holding of the dependency relation, two alignment candidates of [e2][j2] and [e1,e2,e3] [j1,j2,j3] are conceivable (S77). Note that the latter candidate is formed in the condition that the higher level node e1, j1 of the “remaining nodes” e2, j2 have been already aligned, so that the dependency relation may be held. As a result of computing the respective candidates using the evaluation function (S78), the evaluation value of the former becomes higher than that of the latter, and the former candidate is selected as the alignment result (S79). FIG. 9 shows the result of the final dependency structure matching processing on the result of the dependency structure analysis in FIG. 8 by the dependency structure tree.

When the result of the dependency structure matching processing for a certain result of the dependency structure analysis is obtained, the same processing is repeated on the result of the next dependency structure analysis (S80), and, when the alignment result for the results of the dependency structure analysis of all the bilingual sentences are obtained, a series of dependency structure matching processing is ended. By the way, there are some cases where plural results of the dependency structure analysis are obtained for one set of bilingual sentences, however, in this case, the dependency structure matching processing is performed on the respective results of the dependency structure analysis.

Turning to FIG. 2, next, the output processing unit 1.11 outputs the result of the dependency structure alignment to the user by the output unit 1.01 (S56). For example, the result of the dependency structure alignment is converted into the form preferred by the user by the output processing unit 1.11 and output at the output unit 1.01 such as a display.

FIG. 10 shows an example of display in the result of the dependency structure alignment in FIG. 9. The example of translation correspondences 13.1 and the display example in the result of the dependency structure alignment are shown. The example of translation correspondences 13.1 and the result of the dependency structure alignment 13.2 are displayed.

According to the first embodiment, the following effects can be obtained. First, the alignment of the dependency structure can be performed with good accuracy even if the bilingual dictionary does not exist at the start of the processing. Further, since there is no need to use a number of evaluation index numbers and evaluation functions when the alignment of the dependency structure is performed as in the conventional technology, not much time is needed for obtaining optimum (suitable) evaluation index numbers and evaluation functions.

In addition, in this embodiment, since the obtained bilingual dictionary with degree of parallelism is applied not directly but after normalized, in other words, since the alignment of the dependency structure is performed by reducing the credit rating when the degree of parallelism is low, it can be said that refining of the bilingual dictionary obtained by the statistical technique is performed by utilizing both the dependency relations between words and the statistical degree of parallelism. Thus, the alignment of the dependency structure uses the refined bilingual dictionary, and thereby, the accuracy of the alignment can be improved.

Furthermore, since the alignment of the dependency structure using the bilingual dictionary with degree of parallelism is performed first, and after that, the alignment of the “remaining nodes” is performed, the processing can be performed at high speed compared to the case where all nodes are aligned by the same method as the alignment of the “remaining nodes”.

Moreover, in this embodiment, the alignment of all parts of the dependency structures can be performed. In this case, since the coverage is 100%, it is ensured that the original bilingual text can be completed by combining all of the alignment results. For example, by generating the pattern dictionary from the alignment results and performing pattern translation processing using it, the translation result same as the bilingual text can be obtained.

(2) The Second Embodiment

Next, the second embodiment of the invention will be described by referring to the drawings.

The second embodiment is characterized in the following two points of applying phrase for phrase information to the alignment of the dependency structure compared to the above described first embodiment.

1. When the bilingual dictionary with degree of parallelism is generated by the statistical technique, the bilingual dictionary with degree of parallelism is generated utilizing not only strings of plural words but also phrase for phrase information obtained at the time of dependency structure analysis. At the time of judgment on whether the number of words in a string is accepted, the suitable value determined by the user (default value is five) is used in the first embodiment, however, in the second embodiment, the phrase unit obtained at the time of dependency structure analysis is judged as the longest word string.

2. In the dependency structure matching processing, an alignment in which the phrase unit is divided exists, the alignment is performed with the phrase unit as one set.

For example, in the first embodiment, the result of the dependency structure alignment is obtained as sets with the phrase unit neglected as shown in the following example.

tegami wo kaku/write (a) letter

kikai honyaku/machine translation

sisutemu/system

On the other hand, in this second embodiment, since the alignment is performed by considering the phrase unit, the result is obtained as shown in the following example.

tegami/letter

kaku/write

kikai honyaku sisutemu/machine translation system

The dependency structural alignment system of the second embodiment can be also shown by the FIG. 1 according to the first embodiment when the constitution is shown by the functional block diagram. However, the following points are different.

The bilingual dictionary building processing unit 1.3 performs bilingual dictionary generation according to the statistical technique. The bilingual dictionary building processing unit 1.3 is realized as well as in the above described first embodiment, by the above described Document 1, Publication of Japanese Patent Application No. Hei-10-11445, etc. At the time of judgment on whether the number of words in a string is accepted, the suitable value determined by the user (default value is five) is used in the first embodiment, however, the second embodiment is different in the point that the processing is changed to the judgment performed with the phrase unit obtained at the time of dependency structure analysis as the longest word string. In order to utilize the phrase unit for the word string segmentation, the result of the dependency structure analysis unit 1.2 is utilized.

Although the dependency structure matching processing unit 2.4 is for performing alignment of the dependency structure of the original and the translation by utilizing the bilingual dictionary with degree of parallelism 1.6 read by the dictionary reading processing unit 1.5, the processing is partially different from that in the first embodiment in the point that the unit of phrases is used as the unit of alignment.

As below, utilizing the example used in the above described first embodiment, the operation of the second embodiment will be described.

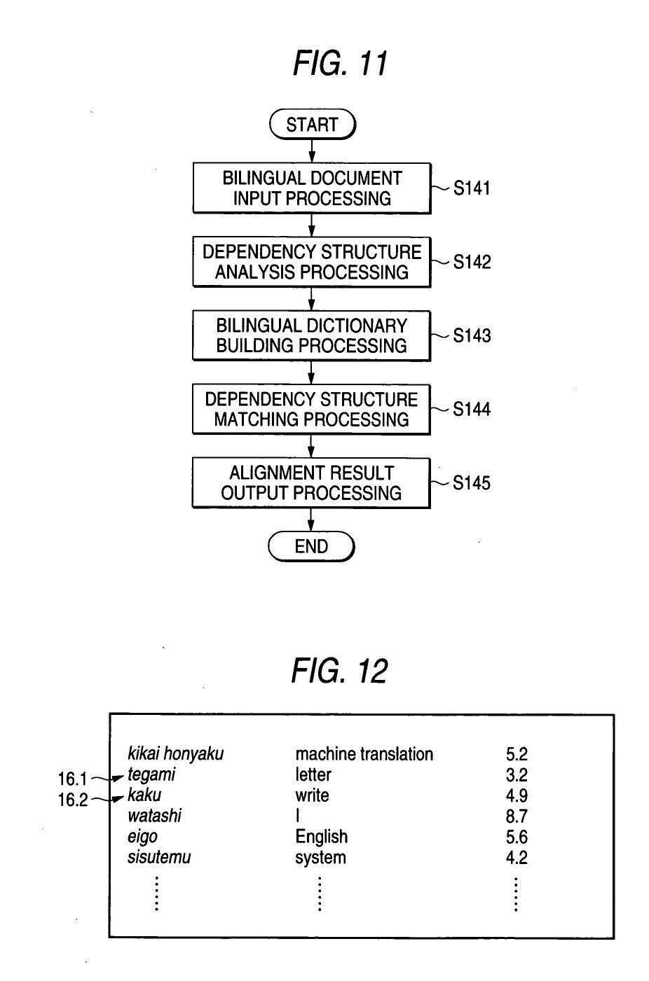

FIG. 11 is a flowchart showing the dependency structure alignment processing in the second embodiment.

In FIG. 11, the point different from the first embodiment is that, in the first embodiment, the result of the morphological analysis is utilized for the bilingual dictionary building processing, while, in the second embodiment, the result of the dependency structure analysis (morphological analysis and parsing) is utilized. That is, the dependency structure analysis processing (S142) is followed by the bilingual dictionary building processing (S143).

In the second embodiment, the bilingual dictionary building processing (S143) is also executed according to the flowchart shown in FIG. 3, which is described in the first embodiment.

Note that, in the first embodiment, at the time of word string extraction (S61 in FIG. 3) in the bilingual dictionary building processing, the word strings consisted of one to n words are extracted, however, in the second embodiment, word strings consisted of one to “the number of words consisting a phrase” are extracted. The phrase for phrase information is obtained from the chunk information shown in FIG. 5. As a result, the generated word string does not exceed the unit of phrases.

FIG. 12 shows an example of the constitution of the bilingual dictionary with degree of parallelism 1.6 in the second embodiment. The example is different from the bilingual dictionary of the first embodiment shown in FIG. 4 in the point that the sentence is divided into units of phrases as “tegami/letter” (16.1) and “kaku/write” (16.2).

After the bilingual dictionary building processing (S143) is ended, in the second embodiment, then, the dependency structure matching processing (S144) also follows.

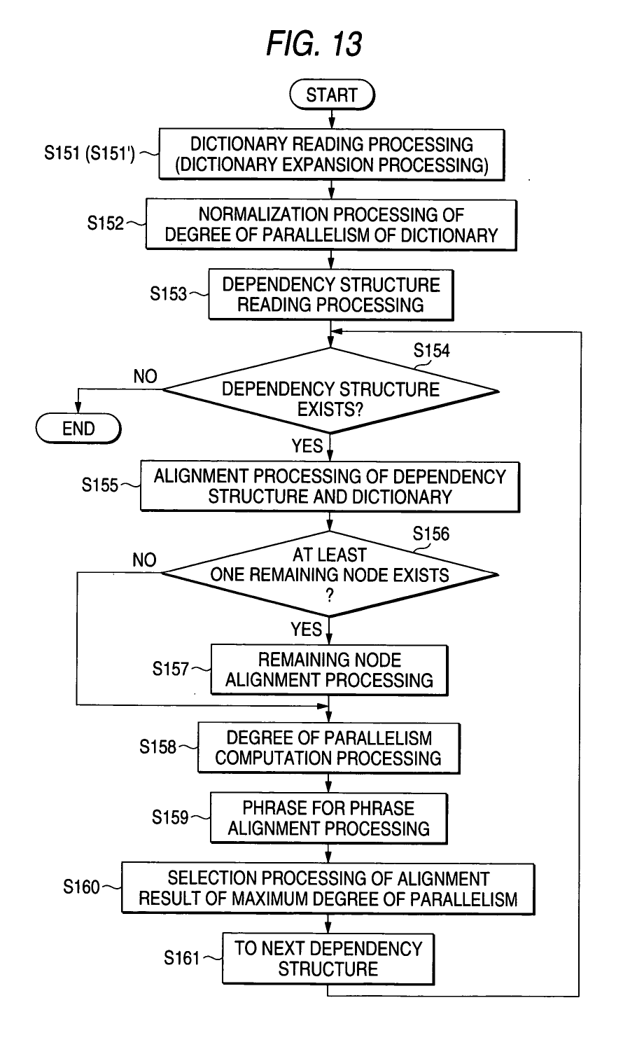

FIG. 13 is a flowchart showing the details of the dependency structure matching processing in the second embodiment, which corresponds to the FIG. 7 according to the first embodiment.

Until the processing of aligning alignment candidates of the “remaining nodes” in Step S159, the flow is the same as that in the first embodiment. Note that, since the point that bilingual dictionary with degree of parallelism 1.6 is made as the phrase for phrase bilingual dictionary is different from the first embodiment, the result of the alignment processing of dependency structure and dictionary (S155) is also different.

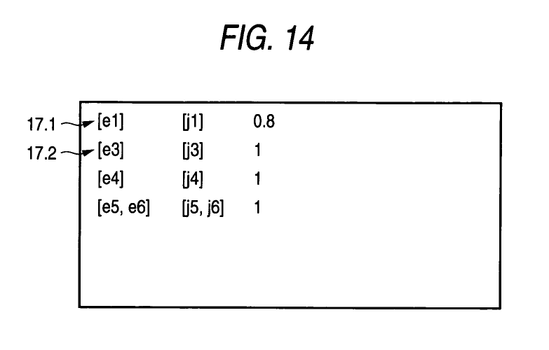

FIG. 14 shows an example of the result of the alignment processing of dependency structure and dictionary in the second embodiment. As shown by assigning the signs of 17.1 and 17.2, write ([e1] [j1]) and letter ([e3] [j3]) are aligned, respectively.

The second embodiment is also characterized by the processing of aligning alignment candidates for “remaining nodes” (S159), and not only aligning the “remaining nodes” but also reviewing and correcting the correspondences to be phrase for phrase are performed. In this review and correct processing, dependency structures are retrieved in units of phrases, and, if the phrase is divided therewithin and aligned (except the case that a part exceeding the phrase unit is included), the alignment is performed with the phrase as one set.

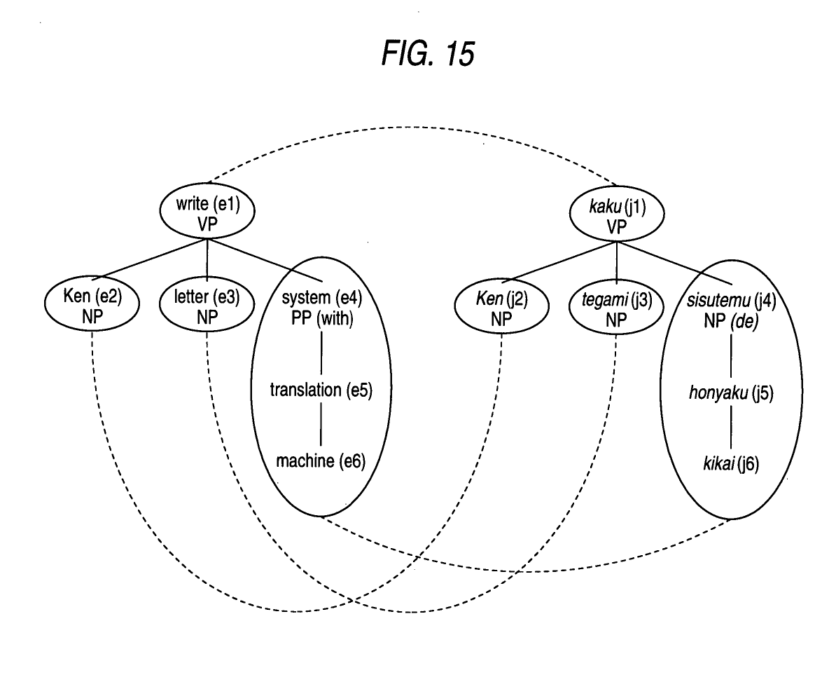

FIG. 15 shows the result of the final dependency structure analysis of the second embodiment. Referring to FIG. 15, the review and correct processing will be described.

For example, in FIG. 15, [e4, e5, e6] are prepositional phrases (pp), and [j4, j5, j6] are nominal phrases (np). However, at the stage that the “remaining node” is aligned, they are divided into two of [e4] [j4] and [e5, e6] [j5, j6]. In this case, the sentences are aligned phrase for phrase with [e4, e5, e6] [j4, j5, j6]. As is the case in the correspondences of “remaining nodes”, correction processing of degree of parallelism is performed so that the phrase for phrase correspondences may be given higher priority.

For example, in the condition in which the mixed phrases of “kikai honyaku” (after which “sisutemu” is not added) and “kikai honyaku sisutemu” occur in the translation examples, and the number of occurrence of “kikai honyaku” (after which “sisutemu” is not added) is larger, (for both the original and the translation), the bilingual dictionary with degree of parallelism as shown in FIG. 12 is generated. Even when the bilingual dictionary with degree of parallelism is generated phrase for phrase, “kikai honyaku sisutem” is sometimes aligned by being divided into “kikai honyaku” and “sisutemu”, such status is reviewed and corrected.

Subsequent processing is the same as that in the first embodiment and the description thereof will be omitted.

According to the second embodiment, the same effect as that in the above described first embodiment can be exerted. Further, the following new effects can be exerted.

The phrase for phrase information can be utilized both (1) at the time of generation of the bilingual dictionary with degree of parallelism by the statistical technique and (2) at the time of alignment in the dependency structures. Thereby, the phrase for phrase alignment of the dependency structure s becomes given higher priority. When alignment is performed phrase for phrase, the dictionary for machine translation becomes easier to be generated from the result of the alignment of the dependency structures. Note that the phrase referred to here is a nominal phrase, a verbal phrase, an adjective phrase, etc. In the case where the alignment is performed in such unit, the phrase can be directly registered as a nominal phrase, a verbal phrase, an adjective phrase, etc.

(3) The Third Embodiment

Next, the third embodiment of the invention will be described by referring to the drawings.

This third embodiment is characterized by utilizing not only the statistically obtained bilingual dictionary with degree of parallelism but also the existing bilingual dictionary compared to the above described second embodiment. In addition, the existing bilingual dictionary is utilized not simply as the bilingual dictionary but for expansion of the dictionary.

Specifically, for example, in the case where there are “kounyuusuru/purchase, kau/buy” in the Japanese-English dictionary, and there is “purchase/kau” in the English-Japanese dictionary, the correspondence of “kounyuusuru/buy” does not exist in the bilingual dictionary, however, by performing the following expansion processing, “kounyuusuru/buy” can be used as the bilingual dictionary. kounyuusuru→purchase→kau→buy=>kounyuusuru→buy

The larger the vocabulary of the bilingual dictionary becomes, the more the accuracy of the alignment of the dependency structure is improved.

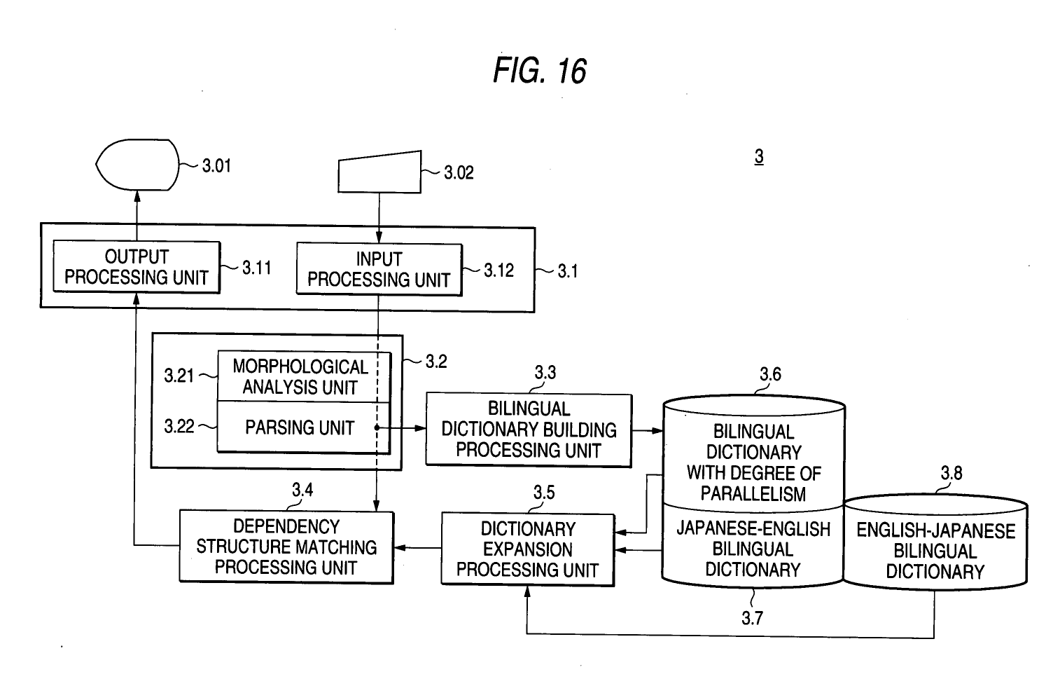

FIG. 16 is a block diagram showing the functional constitution of the dependency structural alignment system 3 as the third embodiment.

The dependency structural alignment system 3 of the third embodiment has an input/output unit 3.1, an dependency structure analysis unit 3.2, a bilingual dictionary building processing unit 3.3, a dependency structure matching processing unit 3.4, a dictionary expansion processing unit 3.5, a bilingual dictionary with degree of parallelism 3.6, a Japanese-English bilingual dictionary 3.7, and an English-Japanese bilingual dictionary 3.8.

The input/output unit 3.1, the dependency structure analysis unit 3.2, the bilingual dictionary building processing unit 3.3, the dependency structure matching processing unit 3.4, and the bilingual dictionary with degree of parallelism 3.6 have the same constitution as those in the second embodiment, and the detailed description thereof will be omitted.

The dictionary expansion processing unit 3.5 reads the bilingual dictionary from the bilingual dictionary with degree of parallelism 3.6, the Japanese-English bilingual dictionary 3.7, and the English-Japanese bilingual dictionary 3.8, and performs the above described expansion of the dictionary, and normalizes the values of degree of parallelism assigned to the respective correspondences so that the dependency structure matching processing unit 3.4 may utilize them.

As below, utilizing the following bilingual exemplary sentences that are assumed to exist in the translation examples, the operation of the third embodiment will be described.

Japanese Sentence: Watashi wa ATM suittingu sisutemu wo kounyuusuru.

English Sentence: I buy the ATM switching system.

The difference between this third embodiment and the second embodiment is (1) the point that the dictionary expansion processing unit 3.5 exists in place of the dictionary reading processing unit, and, in the flowchart of the above described dependency structure matching processing in FIG. 13, the dictionary reading processing (S151) can be replaced by the dictionary expansion processing (S151′), and (2) the point that, accordingly, the existing English-Japanese and Japanese-English bilingual dictionaries are utilized for alignment.

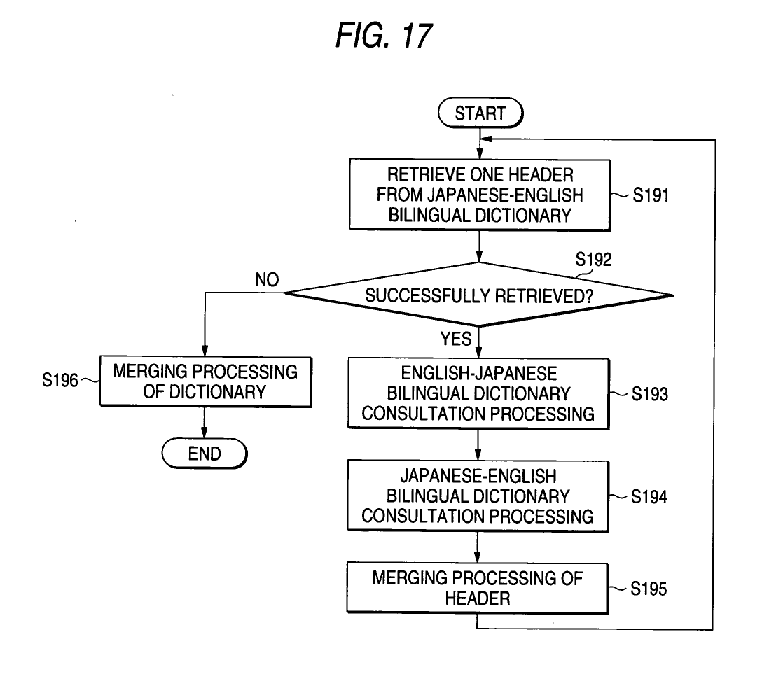

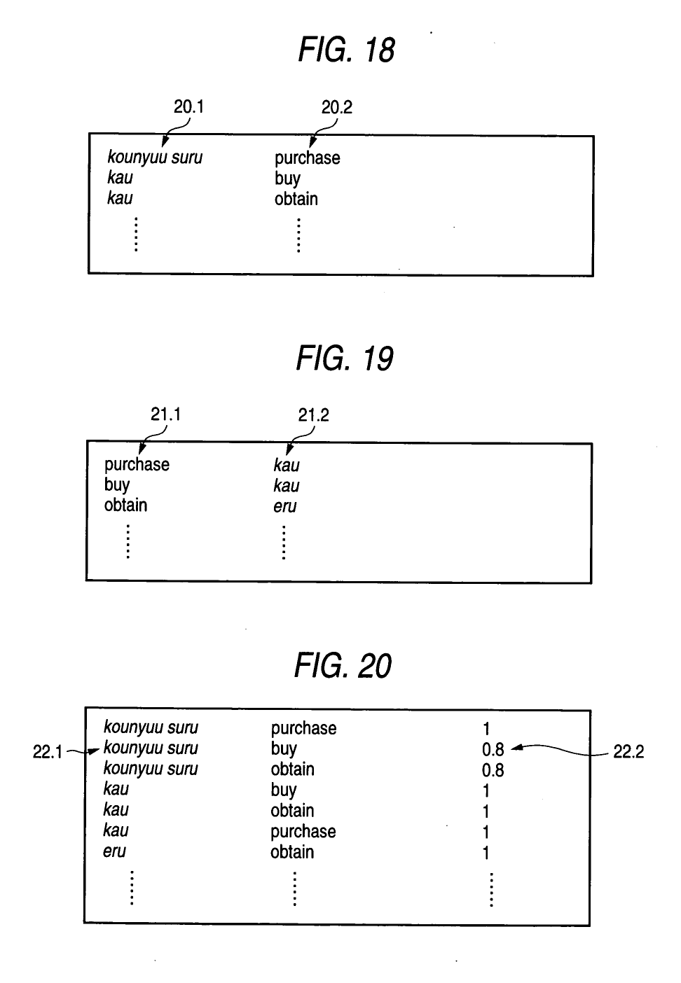

First, the dictionary expansion processing (S151′) will be described by referring to FIG. 17 to FIG. 19. FIG. 17 is a flowchart showing the details of the dictionary expansion processing (S151′), FIG. 18 is an explanatory diagram showing an example of the Japanese-English bilingual dictionary, and FIG. 19 is an explanatory diagram showing an example of the English-Japanese bilingual dictionary.

First, from the Japanese-English bilingual dictionary 3.7, one Japanese header and all English translated words corresponding thereto are retrieved (S191). In the example of FIG. 18, for one Japanese header “kounyuusuru”, its English translated word “purchase” is retrieved. If it is successfully retrieved (S192), then, English-Japanese bilingual dictionary 3.8 is consulted with the retrieved translated word as an index, and its Japanese translation is retrieved (S193). In the example of FIG. 19, for “purchase”, “kau” is retrieved. Further, the Japanese-English bilingual dictionary 3.7 is consulted with the Japanese translated word as an index, and its English translated word is retrieved (S194). Here, “buy” and “obtain” are retrieved for “kau”. Then, correspondences are generated from the initial Japanese header and the final English translated word obtained by the expansion, and they are stored in the expanded dictionary (S195). In the above described example, “kounyuusuru” and “buy”, and “kounyuusuru” and “obtain” become correspondences.

The above described processing is repeated until no unprocessed header of the Japanese-English bilingual dictionary 3.7 exists, when the unprocessed header no longer exists (S192), the bilingual dictionary with degree of parallelism 3.6, the Japanese-English bilingual dictionary 3.7, and the English-Japanese bilingual dictionary 3.8 are merged into the expanded dictionary, duplication is eliminated, and the degree of parallelism is assigned to the respective correspondences that have not yet been assigned with the degree of parallelism (S196).

Note that, when the duplication is eliminated, the existing correspondences with degree of parallelism are given highest priority, and the Japanese-English bilingual dictionary 3.7 and the English-Japanese bilingual dictionary 3.8 are given next priority. In addition, when the degree of parallelism is assigned to the respective correspondences that have not yet been assigned with degree of parallelism, with respect to the correspondences including the same word or word string in either of Japanese or English, the degree of parallelism of the existing correspondences is set higher than that of the expanded correspondences.

For example, the degree of parallelism of the existing correspondences existing in the Japanese-English bilingual dictionary 3.7 or the English-Japanese bilingual dictionary 3.8 is made as 1, and the degree of parallelism of the expanded correspondences is set to 0.8.

FIG. 20 shows an example of the expanded dictionary generated by the dictionary expansion processing. Here, “kounyuusuru/buy” and “kounyuusuru/obtain” are expanded correspondences, and 0.8 is assigned as the respective values of degree of parallelism. On the other hand, for the existing correspondences such as “kounyuusuru/purchase”, 1 is assigned as the value of the degree of parallelism.

The subsequent processing is the same as that in the above described second embodiment, and the detailed description thereof will be omitted.

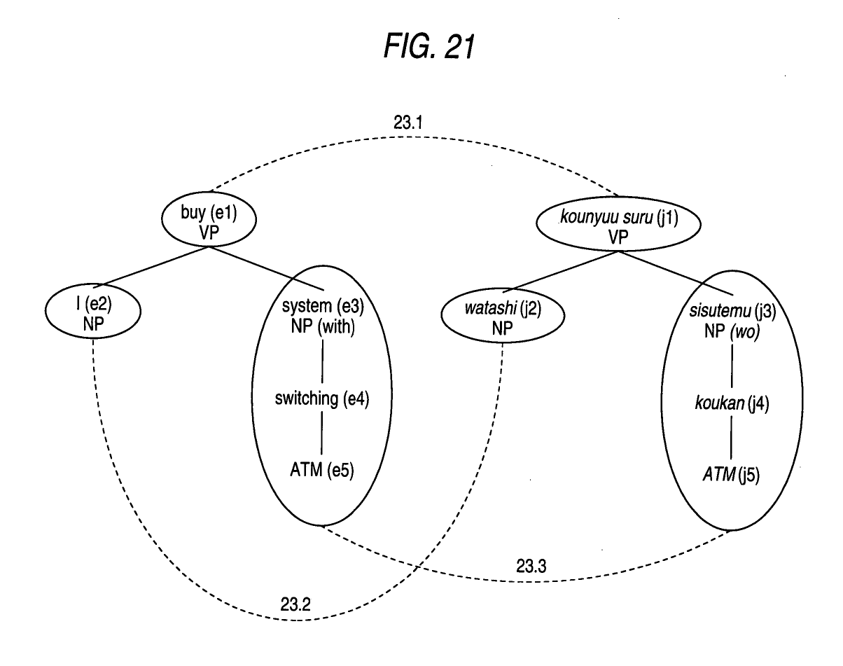

FIG. 21 shows the result of the dependency structure alignment in the third embodiment. Even if there is no correspondence of “buy” and “kounyuusuru” in the bilingual dictionary with degree of parallelism 3.6, the Japanese-English bilingual dictionary 3.7, and the English-Japanese bilingual dictionary 3.8, “buy” and “kounyuusuru” are aligned by using the expanded dictionary.

By the third embodiment, the same effect as that of the above described second embodiment can be also exerted. Further, in addition to this, the following effects can be exerted.

In the third embodiment, by performing expansion of the dictionary, the dependency structures that can be aligned by the bilingual dictionary are increased and the accuracy of alignment can be improved.

Generally, there are various wordings as a translated word of a certain word. However, in the bilingual dictionary used in machine translation etc., not all translated words are registered, and only representative words having certain meanings are registered (for example, there is sometimes a case where, as the translated word of “buy”, both “kau” and “kounyuusuru” are not registered but either one is registered). Therefore, in the case where such bilingual dictionary is used as a key for the alignment of the dependency structure, the lacking of the registered words in the bilingual dictionary becomes a significant problem, however, by the constitution of the third embodiment, this problem can be solved.

Note that, in rare cases, the bilingual dictionary generated by expansion does not have suitable correspondences. For example, the case is as follows.

rikai suru→understand→wakaru→find=>rikaisuru/find?

In such case, there is a possibility that incorrect alignment may be performed by the bilingual dictionary generated by expansion. In response to this, in the constitution of the third embodiment, the degree of parallelism of the bilingual dictionary generated by expansion is made lower than that of the correspondences directly registered in the dictionary, and thereby, the adverse effect by the dictionary expansion can be avoided.

(4) The Fourth Embodiment

Next, the fourth embodiment of the invention will be described by referring to the drawings.

The fourth embodiment is characterized by utilizing the technological idea of the above described first to third embodiments for the generation of the pattern dictionary of the pattern-based type machine translation system.

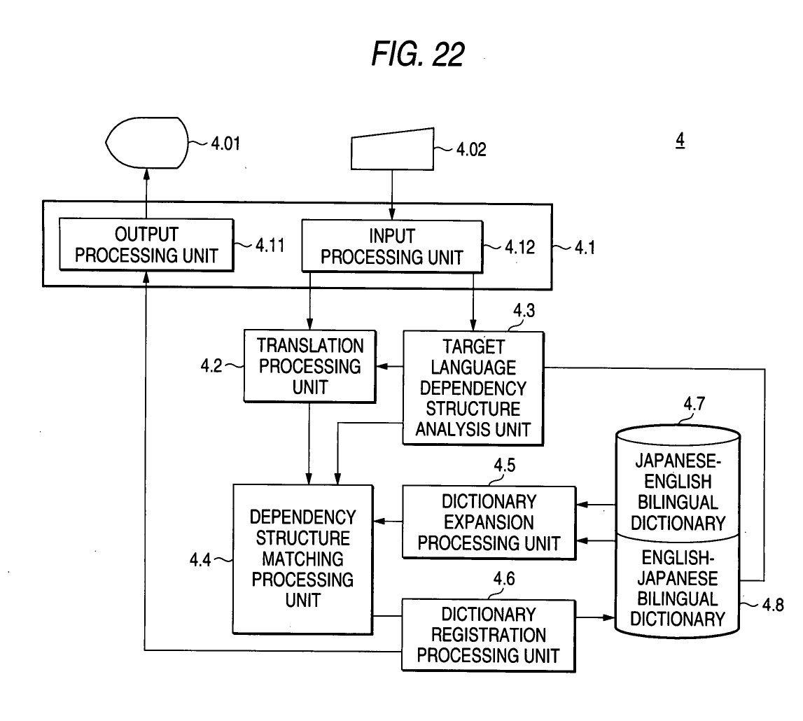

FIG. 22 is a block diagram showing the functional constitution of the dependency structural alignment system (machine translation pattern generation system) 4 as the fourth embodiment.

In FIG. 22, the machine translation pattern generation system 4 of the fourth embodiment has an input/output unit 4.1, a translation processing unit 4.2, a target language dependency analysis unit 4.3, a dependency structure matching processing unit 4.4, a dictionary expansion processing unit 4.5, a Japanese-English bilingual dictionary 4.6, and an English-Japanese bilingual dictionary 4.7.

The input/output unit 4.1 is constituted by an input processing unit 4.12 for inputting a bilingual text (original and translation) and an output processing unit 4.11 for outputting the generated pattern dictionary.

The translation processing unit 4.2 is generally used for translation, however, here, used for acquiring the dependency structures of the original. As the translation processing unit 4.2, for example, “translation processing unit” disclosed in Publication of Japanese Patent Application No. 2002-41512 can be applied.

The reason for applying the translation processing unit 4.2 for acquiring the dependency structures of the original is that the dependency structures acquired by the translation processing unit 4.2 are dependency structures constituted by the combination of the existing bilingual dictionaries (referred to as “translation pattern dictionary” in the above described Publication of Japanese Patent Application No. 2002-41512). By using the existing bilingual dictionary to generate the dependency structure, and acquiring the pattern of the target language corresponding thereto from examples of translation correspondences, the bilingual dictionary can be built up only by adding the bilingual dictionary necessary for restoring example sentences of translation correspondences without changing the existing bilingual dictionary.

The target language dependency structure analysis unit 4.3 is for obtaining the dependency structures on the target language side (translation). For this target language dependency structure analysis unit 4.3, the translation processing unit of the machine translation system can be also utilized. Alternatively, the modification analysis system using the statistical technique of Document 1 described in the first embodiment may be utilized. That is, for the target language side, any dependency structure analysis tool may be applied.

The dependency structure matching processing unit 4.4 of this fourth embodiment is for performing the alignment of the dependency structures of the original and the translation using the dictionary read by the dictionary expansion processing unit 4.5.

In addition, the dictionary expansion processing unit 4.5 of the fourth embodiment performs expansion of the dictionary described in the third embodiment by reading the Japanese-English bilingual dictionary 4.7 and the English-Japanese bilingual dictionary 4.8. The expanded dictionary is stored in the buffer within the dictionary expansion processing unit 4.5, and the dependency structure matching processing unit 4.4 uses the expanded dictionary.

The dictionary registration processing unit 4.6 generates the bilingual dictionary from the alignment result obtained from the dependency structure alignment, and judges whether or not the generated bilingual dictionary has been registered in the existing bilingual dictionary 4.7 or 4.8, and if not registered, registers it to the respective dictionaries 4.7,4.8.

As below, taking an example of the case where the bilingual dictionary (translation pattern) is generated from the following bilingual exemplary sentences input by the user and additionally registered in the existing bilingual dictionary, the operation of the fourth embodiment will be described.

Japanese Sentence: Watashi wa ATM suitting system wo kounyuu suru.

English Sentence: I buy the ATM switching system.

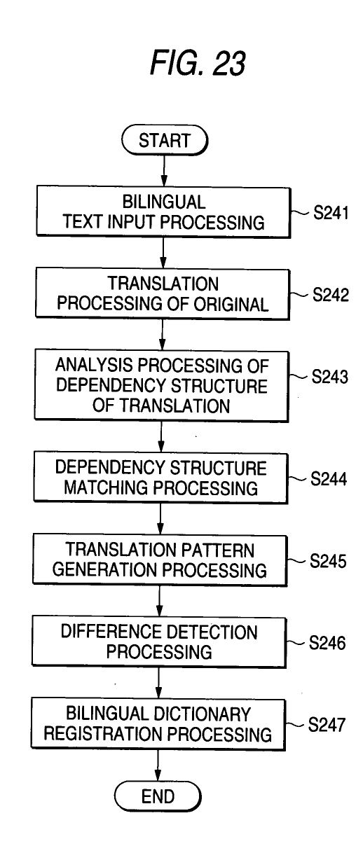

FIG. 23 is a flowchart showing the bilingual dictionary (translation pattern) generation processing in the fourth embodiment.

The user inputs a bilingual text and the kind of dictionary desired to be generated from the input processing unit 4.12 using the input unit 4.01 such as a keyboard (S241). When the bilingual dictionary desired to be generated is the English-Japanese bilingual dictionary, the input processing unit 4.12 passes the English sentences of the bilingual text to the translation processing unit 4.2, and passes the Japanese sentences to the target language dependency structure analysis unit 4.3. On the other hand, When the bilingual dictionary desired to be generated is the Japanese-English bilingual dictionary, the input processing unit 4.12 passes the Japanese sentences of the bilingual text to the translation processing unit 4.2, and passes the English sentences to the target language dependency structure analysis unit 4.3. As below, the processing of the former case will be described as an example.

In the translation processing unit 4.2, the dependency structures of the English sentences are obtained by the translation processing (S242), while in the target language dependency structure analysis unit 4.3, the dependency structures of the Japanese sentences are obtained by the dependency structure analysis processing on the translation (S243).

Next, the respective dependency structures are provided to the dependency structure matching processing unit 4.4, and the dependency structure matching processing is performed (S244). Although the bilingual dictionary with degree of parallelism does not exist, the dependency structure matching processing of the fourth embodiment is also performed according to the same processing procedure as that of the third embodiment. In addition, even when the dictionary is stored in the form of translation pattern, after changed into word or word string correspondences, the method of the third embodiment is applied. The above described FIG. 21 also shows a result example of the dependency structure matching processing of the fourth embodiment.

Next, the dictionary registration processing unit 4.6 generates the bilingual dictionary (translation pattern) in the same form as that of the English-Japanese bilingual dictionary 4.8 utilized in the translation processing unit 4.2 from the result of the alignment of the dependency structure s. Since the English dependency structure obtained by the translation processing unit 4.2 are generated utilizing the English-Japanese bilingual dictionary 4.8, by the reverse processing to the method for generating the dependency structures from the English-Japanese bilingual dictionary 4.8, a new bilingual dictionary can be generated from the dependency structures.

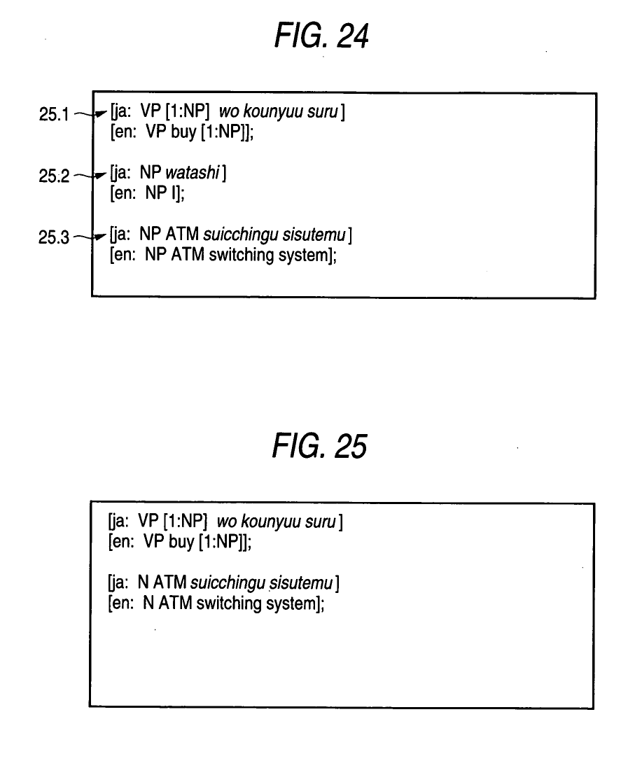

FIG. 24 shows an example of the generated bilingual dictionary. The dictionary (translation pattern) shown by the sign 25.1 in FIG. 24 is generated from the correspondence shown by the sign 23.1 in FIG. 21, the dictionary (translation pattern) shown by the sign 25.2 in FIG. 24 is generated from the correspondence shown by the sign 23.2 in FIG. 21, and the dictionary (translation pattern) shown by the sign 25.3 in FIG. 24 is generated from the correspondence shown by the sign 23.3 in FIG. 21.

Then, the new bilingual dictionary generated in the translation pattern generation processing (S245) and the existing English-Japanese bilingual dictionary 4.8 are compared, and the bilingual dictionary that has not been registered in the existing English-Japanese bilingual dictionary 4.8 is detected (S246). FIG. 25 shows an example of the bilingual dictionary that is detected as not being registered in the existing English-Japanese bilingual dictionary 4.8.

Such unregistered bilingual dictionary is passed to the output processing unit 4.11, and output at the output unit 4.01 such as a CRT display to the user, and newly registered in the existing English-Japanese bilingual dictionary 3.8 (S247).

According to the fourth embodiment, regardless of the translation result of the machine translation system, the currently lacking pattern dictionary becomes easier to be acquired. Among the conventional technologies, there is a method for generating a pattern dictionary for detecting the difference between the translation result of the machine translation system and the correct translation result to cover the difference, however, in the fourth embodiment, without using the translation result of the machine translation system, the lacking pattern dictionary can be generated directly from the original and the correct translation result.

In addition, the dependency structure analysis processing of the target language is not needed to be rigid analysis as utilized in the machine translation etc., the rough analysis such as phrase for phrase modification analysis (for example, statistical modification analysis) can be utilized sufficiently. As a result, the probability of failure in the dependency structure analysis of the target language becomes lower, while the probability of success in the alignment of the dependency structures becomes higher.

Further, since the alignment of the dependency structures according to the embodiment assures the alignment of all parts of the sentences (assures the coverage of 100%), it is assured that the pattern dictionary that can restore the correct example of the translation is generated.

Furthermore, the dictionary can be build up by making the expanded correspondences by the dictionary expansion processing of the third embodiment directly into a dictionary, however, in that case, there is a possibility that incorrect correspondences are registered. In response to this, as the fourth embodiment, the dictionary can be build up with high accuracy by filtering with the alignment result.

(5) Other Embodiments

In the above described respective embodiments, the example in which Japanese is selected as the first language, English is selected as the second language, and the bilingual text to be input is constituted by Japanese and English sentences is shown, however, in the invention, the kind of language is not limited thereto.

In addition, the result of the alignment of the dependency structures that can be acquired in the first to third embodiments can be utilized as a conversion dictionary of all conversion-based (also referred to as rule-based) machine translation systems. That is, the form of the dictionary differs according to the respective systems, however, because the basic of the conversion-based machine translation system is conversion of the constitution tree, the result of the alignment of the dependency structure acquired in the respective embodiments can be utilized as the conversion rule of the constitution tree.

Further, the existing dictionary used in the third embodiment is not limited to the Japanese-English and English-Japanese bilingual dictionaries. For example, that may be the combination of the bilingual terms in a special field and the general bilingual dictionary, or the combination of the statistically acquired dictionary and the existing dictionary. Alternatively, two or more kinds of dictionaries may be used. If two or more kinds of dictionaries are used, the range of expansion is enlarged. Note that, it is desired that the more the range of expansion is enlarged, the lower the value of degree of parallelism is set.

Moreover, in the third embodiment, the expansion is performed in the order that, after the consultation of the Japanese-English dictionary, the consultation of English-Japanese dictionary is performed, however, the expansion may be performed in the reverse order.

In addition, in the fourth embodiment, the operation is described by taking the example in which the pattern-based translation processing unit described in Publication of Japanese Patent Application No. 2002-41512 is applied as the translation processing unit, however, the conversion-based translation processing unit can be applied. Note that, in the pattern-based translation processing described in Publication of Japanese Patent Application No. 2002-41512, since the bilingual dictionary and the grammatical rule are the same, not only the bilingual dictionary but also the grammatical rule can be acquired by this technique.

Further, in the fourth embodiment, the constitution and the operation are described by taking the example without the bilingual dictionary building processing unit (function of generating the statistical bilingual dictionary (bilingual dictionary with degree of parallelism)) however, the system can be equipped with this bilingual dictionary building processing unit.

Furthermore, in the fourth embodiment, the method for automatically generating necessary translation pattern from translation exemplary sentences is described, however, the invention can be also applied to the method for automatically generating necessary translation pattern with the result produced by the user by performing post-correction manually on the result output by the translation processing unit as the translation. In this case, the system to which the invention is applied is a system for automatically generating the translation pattern from the result of the post-correction of the machine translation system.

Moreover, in the third embodiment, the example in which the dictionary obtained by the statistical technique and the existing bilingual dictionary are simultaneously used is shown, and such constitution can be applied to the other embodiments. For example, the constitution in which a unit for counting the number of characters in the input translation exemplary sentence is provided, if the translation exemplary sentence having a hundred or more characters is input, the bilingual dictionary building processing unit is actuated and the dictionaries are simultaneously used, and, if less than hundred characters, only the existing bilingual dictionary is used can be adopted.

As described above, according to the invention, the bilingual dependency structural alignment system or the bilingual dependency structural alignment method having high coverage and capable of aligning the dependency structures of the first language sentences and the second language sentences of the bilingual text without complicating the processing, but with good accuracy, can be provided.

What is claimed is:

1. A bilingual dependency structural alignment system comprising:
dependency structure analysis means for performing dependency structure analysis, in a bilingual document consisted of pairs of sentences of the first language sentences written in the first language and the second language sentences written in the second language, on at least one pair of said first language sentence and said second language sentence, respectively;
a bilingual dictionary with degree of parallelism with a word or word string as a header; and
dependency structure matching processing means for performing alignment on the dependency structures of said first language sentence and said second language sentence that form a pair and is obtained by the dependency structure analysis means with the bilingual dictionary with degree of parallelism, if there is a part that can not be aligned by the bilingual dictionary with degree of parallelism and/or if there are plural candidates of correspondences, obtaining the lacking alignment of the dependency structures or determining optimum correspondence of the plural candidates, while satisfying the condition that the dependency structures are held in said first language sentence and said second language sentence, respectively, and on the condition that the evaluation value with the degree of parallelism becomes maximum.

2. A bilingual dependency structural alignment system according to claim 1, further comprising first bilingual dictionary with degree of parallelism building processing means for building the bilingual dictionary with degree of parallelism with a word or word string as a header from the bilingual document by a statistical technique.

3. A bilingual dependency structural alignment system according to claim 1, further comprising bilingual dictionary with degree of parallelism building processing means, the means including:
plural different kinds of bilingual dictionaries regarding said first language and said second language; and
a dictionary expansion processing unit for expanding dictionary information by forming a pair of headers of said first language and said second language that does not exist in the respective bilingual dictionaries according to information of said plural different kinds of bilingual dictionaries, assigning degree of parallelism to said expanded pair of headers and a pair of headers initially existing in the respective bilingual dictionaries, and setting the degree of parallelism of said expanded pair of headers lower than that of the pair of headers initially existing in the respective bilingual dictionaries, wherein the processing result of the dictionary expansion processing unit is used as the bilingual dictionary with degree of parallelism.

4. A bilingual dependency structural alignment system according to claim 2, further comprising second bilingual dictionary with degree of parallelism building processing means, the means including:
plural different kinds of bilingual dictionaries regarding said first language and said second language; and
a dictionary expansion processing unit for expanding dictionary information by forming a pair of headers of said first language and said second language that does not exist in the respective bilingual dictionaries according to information of said plural different kinds of bilingual dictionaries, assigning degree of parallelism to said expanded pair of headers and a pair of headers initially existing in the respective bilingual dictionaries, and setting the degree of parallelism of said expanded pair of headers lower than that of the pair of headers initially existing in the respective bilingual dictionaries, wherein the processing result of the dictionary expansion processing unit is used as the bilingual dictionary with degree of parallelism.

5. A bilingual dependency structural alignment system according to claim 4, wherein the dependency structure matching processing means utilizes only the bilingual dictionary with degree of parallelism by the second bilingual dictionary with degree of parallelism building processing means, if the number of sentences in the bilingual document is less than the preset number of sentences, and utilizes both the bilingual dictionary with degree of parallelism by the first bilingual dictionary with degree of parallelism building processing means and the bilingual dictionary with degree of parallelism by the second bilingual dictionary with degree of parallelism building processing means, if the number of sentences in the bilingual document is equal to or more than the preset number of sentences.

6. A bilingual dependency structural alignment system according to claim 1, wherein the dependency structure matching processing means is based on phrase for phrase alignment by utilizing phrase information in the result of the dependency structure analysis of the dependency structure analysis means.

7. A bilingual dependency structural alignment system according to claim 2, wherein the first bilingual dictionary with degree of parallelism building means is designed not for exceeding the respective dictionary headers of the bilingual dictionary with degree of parallelism to be built in units of phrases by utilizing the result of the dependency structure analysis of the dependency structure analysis means.

8. A bilingual dependency structural alignment system according to claim 1, wherein the dependency structure analysis means includes a translation processing unit for obtaining the result of the dependency structure analysis from said first language sentences through the translation processing on the first language sentences and a target language dependency structure analysis unit for obtaining the result of the dependency structure analysis from the second language sentences,
the system further comprising dictionary registration processing means for generating a grammatical rule and a bilingual dictionary from the result of the alignment of the dependency structures by the dependency structure matching processing means and newly registering a grammatical rule and a bilingual dictionary not included in the existing ones by taking the difference between the grammatical rule and the bilingual dictionary and a grammatical rule and a bilingual dictionary already used by the translation processing unit.

9. A bilingual dependency structural alignment method comprising:
a dependency structure analysis step for performing dependency structure analysis, in a bilingual document consisted of pairs of sentences of the first language sentences written in the first language and the second language sentences written in the second language, on at least one pair of said first language sentence and said second language sentence, respectively; and
a dependency structure matching processing step for performing alignment on the dependency structures of the first language sentence and the second language sentence that form a pair and is obtained in the dependency structure analysis step using a bilingual dictionary with degree of parallelism with a word or word string as a header, if there is a part that can not be aligned by the bilingual dictionary with degree of parallelism and/or if there are plural candidates of correspondences, obtaining the lacking alignment of the dependency structures or determining optimum correspondence of the plural candidates, while satisfying the condition that the dependency structures are held in said first language sentence and said second language sentence, respectively, and on the condition that the evaluation value with the degree of parallelism becomes maximum.

10. A bilingual dependency structural alignment method according to claim 9, further comprising a first bilingual dictionary with degree of parallelism building processing step for building the bilingual dictionary with degree of parallelism with a word or word string as a header from the bilingual document by a statistical technique.

11. A bilingual dependency structural alignment method according to claim 9, further comprising a bilingual dictionary with degree of parallelism building processing step including dictionary expansion processing for expanding dictionary information, according to information of plural different kinds of bilingual dictionaries regarding said first language and said second language, by forming a pair of headers of said first language and said second language that does not exist in the respective bilingual dictionaries, assigning degree of parallelism to said expanded pair of headers and a pair of headers initially existing in the respective bilingual dictionaries, and setting the degree of parallelism of said expanded pair of headers lower than that of the pair of headers initially existing in the respective bilingual dictionaries, wherein the processing result of the dictionary expansion processing is used as the bilingual dictionary with degree of parallelism.

12. A bilingual dependency structural alignment method according to claim 10, further comprising a second bilingual dictionary with degree of parallelism building processing step including dictionary expansion processing for expanding dictionary information, according to information of plural different kinds of bilingual dictionaries regarding said first language and said second language, by forming a pair of headers of said first language and said second language that does not exist in the respective bilingual dictionaries, assigning degree of parallelism to said expanded pair of headers and a pair of headers initially existing in the respective bilingual dictionaries, and setting the degree of parallelism of said expanded pair of headers lower than that of the pair of headers initially existing in the respective bilingual dictionaries, wherein the processing result of the dictionary expansion processing is used as the bilingual dictionary with degree of parallelism.

13. A bilingual dependency structural alignment method according to claim 12, wherein the dependency structure matching processing step utilizes only the bilingual dictionary with degree of parallelism by the second bilingual dictionary with degree of parallelism building processing step, if the number of sentences in the bilingual document is less than the preset number of sentences, and utilizes both the bilingual dictionary with degree of parallelism by the first bilingual dictionary with degree of parallelism building processing step and the bilingual dictionary with degree of parallelism by the second bilingual dictionary with degree of parallelism building processing step, if the number of sentences in the bilingual document is equal to or more than the preset number of sentences.

14. A bilingual dependency structural alignment method according to claim 9, wherein the dependency structure matching processing step is based on phrase for phrase alignment by utilizing phrase information in the result of the dependency structure analysis of the dependency structure analysis step.

15. A bilingual dependency structural alignment method according to claim 10, wherein the first bilingual dictionary with degree of parallelism building step is designed for not exceeding the respective dictionary headers of the bilingual dictionary with degree of parallelism to be built in units of phrases by utilizing the result of the dependency structure analysis of the dependency structure analysis step.

16. A bilingual dependency structural alignment method according to claim 9, wherein the dependency structure analysis step includes translation processing for obtaining the result of the dependency structure analysis from said first language sentences through the translation processing on the first language sentences and target language dependency structure analysis processing for obtaining the result of the dependency structure analysis from the second language sentences,
the system further comprising a dictionary registration processing step for generating a grammatical rule and a bilingual dictionary from the result of the alignment of the dependency structure by the dependency structure matching processing step and newly registering a grammatical rule and a bilingual dictionary not included in the existing ones by taking the difference of the grammatical rule and the bilingual dictionary and a grammatical rule and a bilingual dictionary already used by the translation processing unit.

17. A bilingual dependency structure alignment program in which the respective steps of the bilingual dependency structural alignment method according to claim 9 are described in codes that enable the computer to perform processing.
